(19) United States
(12) Patent Application Publication
(10) Pub. No.: US 2024/0403562 A1
(43) Pub. Date: Dec. 5, 2024

(54) METHOD AND APPARATUS FOR EXTRACTING TO-DO ITEM, DEVICE, AND STORAGE MEDIUM

(71) Applicant: Beijing Zitiao Network Technology Co., Ltd., Beijing (CN)

(72) Inventors: Siyuan LI, Beijing (CN); Jingsheng YANG, Beijing (CN); Jihua KANG, Beijing (CN)

(21) Appl. No.: 18/680,127

(22) Filed: May 31, 2024

(30) Foreign Application Priority Data
Jun. 2, 2023 (CN) 202310651488.3

(51) Int. Cl. G06F 40/289; G06N 20/00

(52) U.S. Cl. CPC G06F 40/289; G06N 20/00

(57) ABSTRACT

A method and apparatus for extracting a to-do item, a device, and a storage medium are provided. The method includes: obtaining text data to be processed; identifying one or more pieces of original text data from the text data to be processed, in which the original text data is related to a to-do item; for one piece of original text data of the one or more pieces of original text data, determining an information quantity of the piece of original text data; in response to the information quantity of the piece of original text data not satisfying a preset condition, supplementing the piece of original text data with the text data to be processed; and extracting to-do data from the piece of original text data.

### CROSS-REFERENCE TO RELATED APPLICATION

This application claims the priority of Chinese Patent Application No. 202310651488.3 filed on Jun. 2, 2023, the disclosure of which is incorporated by reference herein in its entirety as part of the present application.

### TECHNICAL FIELD

The present disclosure relates to the technical field of natural language processing, and in particular, to a method and apparatus for extracting a to-do item, a device, and a storage medium.

### BACKGROUND

With the development of the Internet technology, a user increasingly communicates with other users through the Internet. For example, the user can communicate with other users by participating in a network meeting or by means of a text. During communication, a to-do item which is about to be performed may be mentioned.

At present, the user responsible for dealing with the to-do item needs to obtain the related information of the to-do item from the contents of communication by himself or herself. The process of extracting the to-do item by the user is inconvenient and inefficient.

### SUMMARY

In this regard, the embodiments of the present disclosure provide a method and apparatus for extracting a to-do item, a device, and a storage medium, which can automatically extract the to-do item from text data to be processed, thereby improving the efficiency of extracting the to-do item.

The technical solution provided by the embodiments of the present disclosure is as follows.

In the first aspect, the embodiments of the present disclosure provide a method for extracting a to-do item, the method includes: obtaining text data to be processed; identifying one or more pieces of original text data from the text data to be processed, in which the original text data is related to a to-do item; for one piece of original text data of the one or more pieces of original text data, determining an information quantity of the piece of original text data; in response to the information quantity of the piece of original text data not satisfying a preset condition, supplementing the piece of original text data with the text data to be processed; and extracting to-do data from the piece of original text data.

In some possible implementations, the identifying one or more pieces of original text data from the text data to be processed includes: obtaining, by using a sentence recognition model, the one or more pieces of original text data based on the text data to be processed.

In some possible implementations, before obtaining, by using a sentence recognition model, the one or more pieces of original text data based on the text data to be processed, the method further includes: dividing the text data to be processed into sentences to obtain text data of a plurality of sentences to be processed; and the obtaining, by using a sentence recognition model, the one or more pieces of original text data based on the text data to be processed includes: identifying, by using the sentence recognition model, the one or more pieces of original text data from the text data of the plurality of sentences to be processed.

In some possible implementations, the sentence recognition model is trained by: obtaining first training data, in which the first training data comprises a positive sample and a negative sample; the positive sample is text data comprising information of a to-do item, and the negative sample is text data not comprising information of a to-do item; and is satisfied, to obtain a trained sentence recognition model.

In some possible implementations, the determining an information quantity of the piece of original text data includes: obtaining, by using an information quantity recognition model, the information quantity of the piece of original text data based on the piece of original text data.

In some possible implementations, the information quantity recognition model is trained by: obtaining second training data, in which the second training data comprises training text data and a label corresponding to the training text data, and the label is used to represent an information quantity of the training text data; and training the information quantity recognition model with the second training data until a second condition is satisfied, to obtain a trained information quantity recognition model.

In some possible implementations, the supplementing the piece of original text data with the text data to be processed includes: supplementing the piece of original text data with first text data adjacent to the piece of original text data in the text data to be processed.

In some possible implementations, the method further includes: in response to the piece of original text data after supplementing satisfying a supplementing condition, supplementing the piece of original text data with second text data adjacent to the piece of original text data in the text data to be processed.

In some possible implementations, the supplementing condition is that a word count of the piece of original text data is less than a word count threshold, or the supplementing condition is that a sentence structure of the piece of original text data is insufficient.

In some possible implementations, the extracting to-do data from the piece of original text data includes: processing the piece of original text data using a natural language processing tool to obtain the to-do data.

In some possible implementations, the processing the piece of original text data using a natural language processing tool to obtain the to-do data includes: determining a to-do type of the piece of original text data; generating an extraction command text for the piece of original text data based on a command text template corresponding to the to-do type and the piece of original text data; and inputting the extraction command text to the natural language processing tool to obtain the to-do data output by the natural language processing tool.

In some possible implementations, the method further includes: creating a to-do task based on the to-do data.

In some possible implementations, the method further includes: pushing information of the to-do task to a user associated with the to-do task.

In the second aspect, the embodiments of the present disclosure provide an apparatus for extracting a to-do item, the apparatus includes: an obtaining unit, configured to obtain text data to be processed; a recognition unit, configured to identify one or more pieces of original text data from the text data to be processed, in which the original text data is related to a to-do item; a determination unit, configured to, for one piece of original text data of the one or more pieces of original text data, determine an information quantity of the piece of original text data; a supplementing unit, configured to, in response to the information quantity of the piece of original text data not satisfying a preset condition, supplement the piece of original text data with the text data to be processed; and an extraction unit, configured to extract to-do data from the piece of original text data.

In some possible implementations, the recognition unit is specifically configured to obtain, by using a sentence recognition model, the one or more pieces of original text data based on the text data to be processed.

In some possible implementations, the apparatus further includes: a sentence dividing unit, configured to divide the text data to be processed into sentences to obtain text data of a plurality of sentences to be processed. The recognition unit is specifically configured to identify, by using the sentence recognition model, the one or more pieces of original text data from the text data of the plurality of sentences to be processed.

In some possible implementations, the sentence recognition model is trained by: obtaining first training data, in which the first training data includes a positive sample and a negative sample; the positive sample is text data including information of a to-do item, and the negative sample is text data not including information of a to-do item; and is satisfied, to obtain the trained sentence recognition model.

In some possible implementations, the determination unit is configured to determine an information quantity of the piece of original text data. Specifically, the determination unit is configured to obtain, by using an information quantity recognition model, the information quantity of the piece of original text data based on the piece of original text data.

In some possible implementations, the information quantity recognition model is trained by: obtaining second training data, in which the second training data includes training text data and a label corresponding to the training text data, and the label is used to represent an information quantity of the training text data; and training the information quantity recognition model with the second training data until a second condition is satisfied, to obtain the trained information quantity recognition model.

In some possible implementations, the supplementing unit is configured to supplement the piece of original text data with the text data to be processed. The supplementing unit is specifically configured to supplement the piece of original text data with first text data adjacent to the piece of original text data in the text data to be processed.

In some possible implementations, the supplementing unit is further configured to, in response to the piece of original text data after supplementing meets a supplementing condition, supplement the piece of original text data with second text data adjacent to the piece of original text data in the text data to be processed.

In some possible implementations, the supplementing condition is that a word count of the piece of original text data is less than a word count threshold, or the supplementing condition is that a sentence structure of the piece of original text data is insufficient.

In some possible implementations, the extraction unit is specifically configured to extract the piece of original text data using a natural language processing tool to obtain the to-do data.

In some possible implementations, the extraction unit is specifically configured to extract the piece of original text data using the natural language processing tool to obtain the to-do data, which includes the following steps. The extraction unit is specifically configured to: determine a to-do type of the piece of original text data; generate an extraction command text for the piece of original text data based on a command text template corresponding to the to-do type and the piece of original text data; and input the extraction command text to the natural language processing tool to obtain the to-do data output by the natural language processing tool.

In some possible implementations, the apparatus further includes: a creation unit, configured to create a to-do task based on the to-do data.

In some possible implementations, the apparatus further includes: a push unit, configured to push information of the to-do task to a user associated with the to-do task.

In the third aspect, the embodiments of the present disclosure provide an electronic device, which includes: one or more processors; and a storage apparatus, storing one or more programs, the one or more programs, when executed by the one or more processors, cause the one or more processors to implement the method for extracting a to-do item in the first aspect.

In the fourth aspect, the embodiments of the present disclosure provide a non-transitory computer-readable medium, storing a computer program thereon, the computer program, when executed by a processor, implements the method for extracting a to-do item in the first aspect.

In the fifth aspect, the embodiments of the present disclosure provide a computer program product, when computer program product is running on a device, causes the device to execute the method in the first aspect.

### BRIEF DESCRIPTION OF DRAWINGS

FIG. 1 is a schematic diagram of a scenario of a method for extracting a to-do item provided by the embodiments of the present application;

FIG. 2 is a flowchart of a method for extracting a to-do item provided by the embodiments of the present application;

FIG. 3 is a schematic diagram of a process of extracting a to-do item provided by the embodiments of the present application;

FIG. 4 is a structural schematic diagram of an apparatus for extracting a to-do item provided by the embodiments of the present application; and

FIG. 5 is a schematic diagram of a basic structure of an electronic device provided by the embodiments of the present application.

### DETAILED DESCRIPTION

In order to facilitate understanding and illustrating of the technical solution provided by the embodiments of the present disclosure, the background technology of the present disclosure will be explained below.

It should be noted that, unless otherwise defined, all the technical and scientific terms used herein have the same meanings as commonly understood by one of ordinary skill in the art to which the present disclosure belongs. The terms “first”, “second”, etc., which are used in the present disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “left,” “right” and the like are only used to indicate relative position relationship, and when the position of the object which is described is changed, the relative position relationship may be changed accordingly.

At present, a user can communicate with other users about a to-do item in a plurality of ways. The users may have a discussion on the to-do item that needs to be completed and assign the to-do item to determine a user to deal with the to-do item. For example, in a scenario of a network meeting, users can communicate about the to-do item through the network meeting. During communication, the user for dealing with the to-do item needs to record information of the to-do item such that the to-do item can be completed subsequently based on the recorded information. Alternatively, the user needs to view meeting records to obtain the to-do item from the meeting records. For another example, in a scenario of a chat, the user needs to read a chat text to organize the to-do item. In this way, the user for dealing with the to-do item needs to organize the to-do item by himself or herself. The process of organizing the to-do item by the user is inconvenient and inefficient.

On this basis, embodiments of the present disclosure provide a method and apparatus for extracting a to-do item, a device, and a storage medium. The method includes: firstly, obtaining text data to be processed; identifying one or more pieces of original text data related to a to-do item from the text data to be processed; for one piece of original text data of the one or more pieces of original text data, determining an information quantity of the piece of original text data; and in response to the information quantity of the piece of original text data not satisfying a preset condition, supplementing the piece of original text data with the text data to be processed. The supplemented original text data includes complete information of the to-do item. Finally, the to-do data is extracted from the piece of original text data. In this way, automatic extraction of accurate to-do data can be realized and the user experience can be improved.

For ease of understanding of the technical solutions provided by the embodiments of the present application, a scenario to which the method for extracting a to-do item provided by the embodiments of the present application is applied is described below in conjunction with a network meeting scenario.

It needs to be noted that the network meeting scenario shown in FIG. 1 is merely a scenario example in which the embodiments of the present disclosure can be achieved. The applicable scope of the embodiments of the present disclosure is not limited by any aspect of the network meeting scenario. The embodiments of the present disclosure can be applied to any feasible scenario.

As shown in FIG. 1, a user 101 participates in a network meeting using a corresponding client 102. The client 102 is connected to a server 103. The server 103 is connected to other servers through a network. The client 102 acquires a speech and an image of the user to generate meeting audio and video data and sends the meeting audio and video data to the server 103. The server 103 sends the meeting audio and video data generated by the client 102 to other servers and sends meeting audio and video data generated by other servers to the client 102. The client 102 provides a service of participating in the network meeting to the user based on the acquired meeting audio and video data. The server 103 firstly converts meeting audio data included in the meeting audio and video data into text data to be processed after the network meeting ends or during the network meeting. The server 103 performs text recognition on the text data to be processed to identify one or more pieces of original text data from the text data to be processed. The original text data includes information of a to-do item. The server 103 then performs information quantity analysis on the original text data to determine an information quantity of each piece of original text data. If the information quantity of the original text data is insufficient, it indicates that the complete information of the to-do item cannot be extracted from the original text data. The original text data with insufficient information quantity is supplemented with the text data to be processed. Finally, the server 103 extracts to-do data from the original text data. The server 103 can send the to-do data to the client 102 such that the client 102 displays the to-do data for the user. Alternatively, the server 103 automatically creates a to-do task based on the to-do data, so as to promote the user to execute the to-do task. In this way, the user does not need to manually record or query a to-do item, and the efficiency of dealing with the to-do item by the user is improved.

For ease of understanding of the method for extracting a to-do item provided by the embodiments of the present disclosure, the method for extracting a to-do item provided by the embodiments of the present disclosure is described below in conjunction with the drawings.

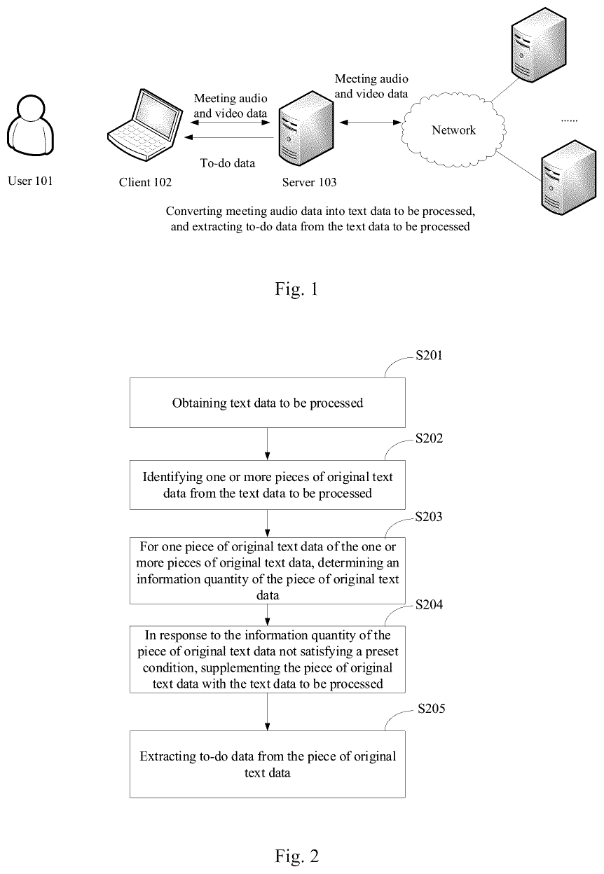

With reference to FIG. 2, which shows a flowchart of a method for extracting a to-do item provided by the embodiments of the present disclosure, the method includes steps S201 to S205.

S201: obtaining text data to be processed.

The text data to be processed is text data that may include a content of a to-do item. The embodiments of the present disclosure do not limit a source of the text data to be processed. As an example, the text data to be processed can be meeting text data obtained by processing meeting speech data using a speech recognition technique. For example, the automatic speech recognition (ASR) technique is used to identify the meeting speech data to obtain the text data to be processed. As another example, the text data to be processed can also be text data input by the user for extraction of a to-do item. The embodiments of the present disclosure are not limited in this aspect.

It can be understood that when the obtained text data to be processed is from a multimedia meeting, the text data to be processed can be generated based on a meeting content after the meeting ends, or the text data to be processed can be generated in real time or in quasi real time along with the meeting content during the meeting.

In some possible implementations, after the text data to be processed is obtained, the text data to be processed is firstly preprocessed. As an example, preprocessing is to replace a key word. The text data to be processed may include a word that needs to be replaced. For example, in order to protect the personal privacy of the user, a user name of the user is replaced with a general name. For example, a specific user name is replaced with a user serial number, and different user names correspond to different general names to distinguish different users.

S202: identifying one or more pieces of original text data from the text data to be processed.

After the text data to be processed is obtained, the original text data included in the text data to be processed is firstly identified. The original text data is text data related to a to-do item and includes the information of the to-do item.

The embodiments of the present disclosure do not limit a method of identifying the original text data from the text data to be processed. In a possible implementation, identifying a word related to the to-do item and included in the text data to be processed. A sentence to which the identified word related to the to-do item is taken as the original text data. In another possible implementation, a model capable of identifying the original text data is pre-trained, and then the text data to be processed is input to the model to obtain the original text data output by the model. The embodiments of the present disclosure provide a specific implementation of identifying the original text data using a sentence recognition model, which will be described below.

The embodiments of the present disclosure do not limit a division way and a quantity of the original text data. In some possible implementations, the text data to be processed is divided through punctuation. Each sentence is a unit of text data. In some other possible implementations, the text data to be processed is meeting text data. The text data to be processed may be divided according to speaking users. The text data of speaking by each user each time is a unit of text data. Each piece of original text data identified from the text data to be processed is a unit of text data. The number of pieces of original text data identified from the text data to be processed may be one or more.

S203: for one piece of original text data of the one or more pieces of original text data, determining an information quantity of the piece of original text data.

In the case that the number of the original text data is one, the original text data is processed. For ease of description, in the following, in order to distinguish the piece of original text data from other original text data of the one or more pieces of original text data extracted from the text to be processed, the piece of original text data is called as target text data. In the case that the number of the original text data is a plurality, one piece of original text data of the one or more pieces of original text data is processed. Similarly, for ease of description, the piece of original text data is called as target text data below.

The information quantity is used to measure how much information of a to-do item included in the text data includes. It can be understood that, taking the text data to be processed being meeting text data as an example, in some cases, a plurality of users need to communicate for a plurality of times to determine a to-do item. Correspondingly, the information of the to-do item is distributed in a plurality of pieces of text data. The information quantity included in one piece of text data may be insufficient, and it is difficult to obtain the complete to-do data by analysis only based on one piece of text data.

Information quantity analysis is performed on the target text data. The embodiments of the present disclosure do not limit the way of analyzing the information quantity of the target text data. In a possible implementation, an information quantity recognition model for determining the information quantity is pre-trained. The information quantity of the target text data is determined using the information quantity recognition model. The embodiments of the present disclosure provide a specific implementation of determining the information quantity of the target text data using the information quantity recognition model, which will be described below. In another possible implementation, a word related to the to-do item and included in the target text data can be identified, and the information quantity of the target text data can be determined based on the number of the identified word.

S204: in response to the information quantity of the piece of original text data not satisfying a preset condition, supplementing the piece of original text data with the text data to be processed.

The preset condition is used to determine whether the information quantity of the piece of original text data, i.e., the target text data is sufficient. The preset condition can be set based on a requirement for extracting the to-do item. The embodiments of the present disclosure do not limit the specific content of the preset condition. As an example, the preset condition is that the information quantity of the piece of original text data is greater than or equal to a preset information quantity threshold.

When the information quantity of the target text data satisfies the preset condition, it indicates that the information quantity of the target text data is sufficient. In the case where the information quantity of the target text data satisfies the preset condition, the to-do data can be extracted from the target text data to obtain the to-do data with a complete information quantity.

When the information quantity of the target text data does not satisfy the preset condition, it indicates that the information quantity of the target text data is insufficient and the text data needs to be added. The target text data is supplemented with the text data to be processed. In some possible implementations, the context of the target text data has much relation with the to-do item, and the target text data is supplemented with the text data of the context of the target text data in the text data to be processed. As an example, the embodiments of the present disclosure provide a specific implementation of supplementing the piece of original text data, i.e., the target text data, with the text data to be processed, which will be described below. In some other possible implementations, a word related to the to-do item and included in the target text data is identified. The target text data is supplemented with the text data including such a word in the text data to be processed. The supplemented target text data includes a plurality of units of text data.

S205: extracting to-do data from the piece of original text data.

The target text data, i.e., the piece of original text data, may include other text data not related to the to-do item. Extraction processing is performed on the target text data to extract the to-do data from the target text data.

In a possible implementation, words related to the to-do item and included in the target text data are identified, and the identified words are used to constitute the to-do data. In another possible implementation, the target text data is processed using a natural language processing tool to obtain the summarized to-do data. The embodiments of the present disclosure provide a specific implementation of processing the target text data using the natural language processing tool to obtain the to-do data, which will be described below.

It should be noted that the embodiments of the present disclosure do not limit the type of the to-do data. As an example, the to-do data extracted from the target text data is text data. As another example, the to-do data extracted from the target text data is audio data or image data or video data related to the target text data.

The to-do data extracted from the target text data can be shown to the user associated with the to-do item, or a to-do task is established for the user associated with the to-do item based on the to-do data.

The user associated with the to-do item can be a user providing the text data to be processed, or a user associated with the text data to be processed, or a user determined based on the extracted to-do data to deal with the to-do item. For example, the user associated with the text data to be processed can be a user corresponding to a user name included in the text data to be processed. The user that needs to deal with the to-do item can be a user corresponding to the user name included in the to-do data.

In an implementation, in order to protect the privacy of the user, the specific user name included in the text data to be processed is filtered in advance, and a general name corresponding to the user name is established. The user name included in the text data to be processed is replaced with the general name corresponding to the user name. After the to-do data is obtained by processing, the user name corresponding to the general name can be determined based on the general name included in the to-do data. The user corresponding to the user name is then taken as the user that needs to deal with the to-do item.

As an example, after the to-do data is obtained, the to-do data is displayed to the user, so that the user knows the assigned to-do item. The embodiments of the present disclosure do not limit the way of triggering to display the to-do data to the user. In a possible implementation, after the to-do data is extracted, the to-do data is automatically displayed to the user. In another possible implementation, the user triggers to generate an instruction of displaying the to-do item, and the to-do data is displayed to the user in response to obtaining the instruction of displaying the to-do item.

It needs to be noted that when the to-do data includes the general name for replacing the user name, the general name needs to be replaced with the user name corresponding to the general name before the to-do data is displayed to the user. In this way, it is convenient for the user viewing the to-do data to determine the specific user related to the to-do item.

As another example, a to-do task is established based on the generated to-do data. In this way, automatic creation of the to-do task can be realized without requiring the user to manually add the to-do task, which improves the efficiency of processing the to-do item.

Further, after the to-do task is established, the information of the to-do task is pushed to the user associated with the to-do task. For example, in the network meeting scenario, the client for providing the network meeting service to the user further has a to-do task management function. The client creates the to-do task based on the to-do data and pushes the information of the to-do task that has been created to the user. The information of the to-do task includes, for example, a task theme, a task content, a related user, and task completion time. The client can push the information of the to-do task to the user by means of a pop-up window, by sending an e-mail, or by a chat conversation.

As can be known based on the above related contents of S201 to S205, in this way, the to-do data can be automatically extracted from the text data to be processed without requiring the user to manually record or manually query the information of the to-do item, which facilitates the assigning of the to-do item, improves the efficiency of dealing with the to-do item, and improves the use experience of the user.

In some possible implementations, a sentence recognition model is pre-trained. The sentence recognition model is configured to identify the original text data included in the text data to be processed. The original text data related to the to-do item can be determined from the text data to be processed using the sentence recognition model. A training process of the sentence recognition model and a process of identifying the original text data using the sentence recognition model are described below.

The embodiments of the present application do not limit a model architecture of the sentence recognition model. As an example, the sentence recognition model takes a Bidirectional Encoder Representations from Transformers (BERT) model architecture.

Obtaining first training data. The first training data includes a positive sample and a negative sample. The positive sample is text data including the information of a to-do item, i.e., text data related to the to-do item. The negative sample is text data not including the information of a to-do item, i.e., text data unrelated to the to-do item. The positive sample and the negative sample can be established in advance.

Training the sentence recognition model with the first training data until a first condition is satisfied, to obtain the trained sentence recognition model. The first condition is a condition for determining the completion of training of the sentence recognition model. For example, the first condition is that the number of training times reaches a number threshold. For another example, the first condition is that an accuracy degree of the sentence recognition model meets a preset requirement.

Correspondingly, one or more pieces of original text data are obtained based on the text data to be processed using the trained sentence recognition model. The text data to be processed is taken as input data to the sentence recognition model to obtain an output result of the sentence recognition model. The output result of the sentence recognition model includes a label of the text data to be processed. The original text data can be determined based on the label of the text data to be processed.

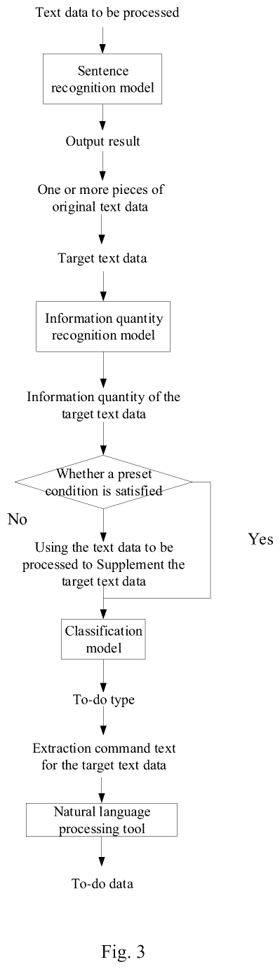

With reference to FIG. 3, which shows a schematic diagram of a process for extracting a to-do item provided by the embodiments of the present disclosure. The text data to be processed is input to the sentence recognition model to obtain the output result of the sentence recognition model. The one or more pieces of original text data included in the text data to be processed can be determined based on the output result of the sentence recognition model.

In some cases, the positive sample and the negative sample included in the first training data both are in units of sentences. That is, both the positive sample and the negative sample are separate sentences. Before the text data to be processed is input to the sentence recognition model, dividing the text data to be processed into sentences firstly, to obtain text data of a plurality of sentences to be processed. The embodiments of the present disclosure do not limit an implementation mode of dividing the text data to be processed into sentences. For example, the text data to be processed can be divided into sentences using a sentence dividing tool. For another example, the text data to be processed is divided into sentences based on punctuations included in the text data to be processed, e.g., punctuations such as full stop, question mark, and exclamation point that are used to represent the end of a sentence. The text data of the plurality of sentences to be processed obtained after sentence division is used as the input to the sentence recognition model to obtain the output result of the sentence recognition model. The output result includes a label corresponding to the text data of each sentence to be processed. The original text data can be determined based on the label corresponding to the text data of each sentence to be processed.

In some implementations, the information quantity of the target text data is determined using an information quantity recognition model. The information quantity recognition model is configured to identify the information quantity included in the target text data. A training process of the information quantity recognition model and a process of determining the information quantity of the target text data using the information quantity recognition model are described below.

The embodiments of the present disclosure do not limit a model architecture of the information quantity recognition model. As an example, the information quantity recognition model adopts a Bidirectional Encoder Representations from Transformers (BERT) model architecture.

Obtaining second training data. The second training data includes training text data and a label corresponding to the training text data. The label is used to represent an information quantity of the training text data. For example, a value of the label includes 0 and 1. The label having the value of 0 represents that the training text data has no information quantity related to the to-do item. The label having the value of 1 represents that the training text data has the information quantity related to the to-do item. The second training data can be annotated in advance based on the information quantity of the to-do item that the training text data has.

Training the information quantity recognition model with the second training data until a second condition is satisfied, to obtain the trained information quantity recognition model. The second condition is a condition for determining the completion of training of the information quantity recognition model. For example, the second condition is that the number of training times reaches a number threshold. For another example, the second condition is that an accuracy degree of the information quantity recognition model meets a preset requirement.

The information quantity of the target text data is obtained based on the target text data using the trained information quantity recognition model. The target text data is input to the information quantity recognition model to obtain the information quantity of the target text data output by the information quantity recognition model.

As shown in FIG. 3, the target text data is input to the information quantity recognition model to obtain the information quantity of the target text data output by the information quantity recognition model.

In the case where the information quantity of the target text data is determined not to meet the preset condition, the target text data is supplemented with the text data to be processed.

As shown in FIG. 3, after the information quantity of the target text data is obtained, whether the information quantity of the target text data meets the preset condition is determined. In the case where the information quantity of the target text data meets the preset condition, subsequent processing is performed. In the case where the information quantity of the target text data does not meet the preset condition, the target text data is supplemented with the text data to be processed.

In a possible implementation, the target text data is supplemented with first text data adjacent to the target text data in the text data to be processed.

The embodiments of the present disclosure do not limit the way of determining the first text data. As an example, the first text data is within a small range, including a previous piece of text data before the target text data and a next piece of text data after the target text data in the text data to be processed.

For example, the target text data is “Speaker 1: please send the processing result to me”. The information quantity of the target text data is 0. The target text data is supplemented with the previous piece of text data before the target text data and next piece of text data after the target text data. The supplemented target text data is as follows.

Speaker 11: I will process the data obtained by this data collection.

Speaker 1: please send the processing result to me.

Speaker 11: I will send it to your mailbox.

It needs to be noted that the way of determining the first text data described above can be configured in advance based on a supplementing requirement. The person skilled in the art can determine the first text data based on the requirement of supplementing the target text data. For example, the range of the first text data includes previous five pieces of text data before the target text data and next two pieces of text data after the target text data in the text data to be processed.

In some possible implementations, the supplemented target text data may still have the problem of less content. Whether the supplemented target text data meets a supplementing condition is determined. The supplementing condition is a preset condition for determining whether or not to continue supplementing the target text data.

The embodiments of the present disclosure do not limit a specific content of the supplementing condition. As an example, in some scenarios, when the target text data has a few words, there is a larger probability that the information quantity related to the to-do item included in the target text data is insufficient. Correspondingly, the supplementing condition is that a word count of the piece of original text data, i.e., the target text data, is less than a word count threshold. The word count threshold is a minimum word count that the target text data is required to reach. When the word count of the supplemented target text data is determined to be less than the word count threshold, it indicates that the supplemented target text data has a few words, and the target text data may still have the problem of insufficient information quantity.

As another example, a sentence structure of the target text data can be analyzed. In some scenarios, a sentence including complete information quantity of the to-do item includes at least three sentence structures: subject, predicate, and object. The subject is the user that executes the to-do item. The predicate is a way of executing the to-do item. The object is a specific content of the to-do item. Moreover, an adverbial may also be included. The adverbial is the time or the position for executing the to-do item. When the sentence structures of the target text data are insufficient, for example, there is no subject, the user executing the to-do item cannot be determined, and the target text data may still have the problem of insufficient information quantity.

In the case where the target text data is determined to have the problem of insufficient information quantity based on the supplementing condition, the target text data is supplemented again with second text data adjacent to the target text data in the text data to be processed. The embodiments of the present disclosure do not limit the way of determining the second text data. As an example, the second text data includes a previous piece of text data before the target text data and a next piece of text data after the target text data in the text data to be processed. In some implementations, the quantity of the second text data is less than the quantity of the first text data. That is, the quantity of the text data supplemented again is less than the quantity of the text data supplemented for the first time, thus avoiding that overly adding the target text data results in the redundancy of the target text data.

Further determination can be performed on the target text data that may be insufficient in information quantity based on the supplementing condition to find the target text data having insufficient information quantity timely, and the target text data is supplemented again. In this way, it can be ensured that the information quantity included in the supplemented target text data is sufficient, and the complete to-do data can be extracted based on the target text data.

It needs to be noted that whether the supplemented target text data meets the supplementing condition is determined after the target text data is supplemented with the second text data. When the word count of the supplemented target text data does not meet the supplementing condition, the second text data is determined from the text data to be processed again and used to supplement the target text data. The operations are repeated in this way until the supplemented target text data meets the supplementing condition.

In some possible implementations, the target text data includes information unrelated to the to-do item. The to-do data is extracted from the target text data using a natural language processing tool. The natural language processing tool can summarize the target text data to refine the information related to the to-do item. The embodiments of the present disclosure do not limit the specific type of the natural language processing tool. For example, the natural language processing tool is Chat Generative Pre-trained Transformer (ChatGPT).

When the to-do data is extracted from the target text data using the natural language processing tool, a command for processing the target text data needs to be input to the natural language processing tool.

In some possible implementations, the command for processing the target text data is generated using a pre-configured general text template.

The general text template is, for example, “the following is a text fragment, please summarize a to-do item in combination with the content. Requirements: 1. A specific to-do item needs to be output. 2. The output format must be “to-do item: xx”, and the length of the to-do item is not greater than 40 words”.

The general text template is spliced with the target text data to obtain the command for processing the target text data.

As an example, the target text data is “Speaker 1: I want to see the analysis result of the experimental data. Speaker 2: OK, I will send it to you after collation”. The generated command for processing the target text data is as follows.

The following is a text fragment, please summarize a to-do item in combination with the content. Requirements: 1. A specific to-do item needs to be output. 2. The output format must be “to-do item: xx”, and the length of the to-do item is not greater than 40 words:

The text fragment is as follows.

Speaker 1: I want to see the analysis result of the experimental data.

Speaker 2: OK, I will send it to you after collation.

In some other possible implementations, the to-do items included in the target text data have different types. Different to-do types have corresponding pre-configured command text templates.

After the target text data is determined, the to-do type of the target text data is determined. The to-do type can be determined in advance by classifying to-do items that may be dealt with. As an example, as shown in Table 1, which shows to-do types provided by the embodiments of the present disclosure.

TABLE 1

| First-Level | | |
|---|---|---|
| Type | Second-Level Type | Third-Level Type |
| Event | Arrange/Organize/Schedule | |
| | Contact | |
| | Drag | |
| | Appoint | |
| | Hold | |
| Task | Processing task mentioned | Synchronize (object) (information), |
| | information | confirm/see/study/ask/assess/digest |
| | | (information), align/interlink/follow |
| | | up/follow/encounter/find (object), |
| | | consult/know/discuss/talk, process, run, |
| | | collect/gather/summarize (information) |
| | | Integrate/collate/comb |
| | | (solution/document), |
| | | share/send/provide/transmit (document), |
| | | perfect/define (solution) |
| | | Report/speak/say |
| | Others | |

The to-do types shown in Table 1 include the first-level type, the second-level type, and the third-level type. The second-level type is a subdivision type of the first-level type. The third-level type is a subdivision type of the second-level type.

Each second-level type included in the event type has a corresponding command text template. For example, the target text data belongs to the “appoint” type in the “event” type. The command text template corresponding to the “appoint” type is “the following is a text fragment, please summarize a content that needs to appoint and summarize a to-do item in combination with the content”.

Each third-level type included in the processing task mentioned information type has a corresponding command text template. For example, the target text data belongs to the “report” type included in the “processing task mentioned information” type in the “task” type. The command text template corresponding to the “report” type is “please summarize a content that needs to report based on the following text fragment and summarize a to-do item in combination with the content”.

When the target text data is of other types included in the task type, the extraction command text is generated using the general text template.

As an example, the to-do type of the target text data can be determined using a classification model. The classification model is pre-trained using training data including a sample text and a type label corresponding to the sample text.

As shown in FIG. 3, the target text data having the information quantity meeting the preset condition or the supplemented target text data is input to the classification model to obtain the to-do type of the target text data output by the classification model.

As another example, type word detection is performed on the target text data. For example, the target text data includes “see”. After “see” is detected, the to-do type of the target text data is determined as the “see” type.

The command text template corresponding to the to-do type includes a command text related to the to-do type. As an example, the to-do type is the see type, and the corresponding command text template is “the following is a text fragment, please summarize a content that needs to see and summarize a to-do item in combination with the content. Requirements: 1. A specific to-do item needs to be output. 2. The output format must be “to-do item: xx”, and the length of the to-do item is not greater than 40 words”. “Please summarize a content that needs to see” included in the command text template is the command text related to the to-do type.

The extraction command text for the target text data is generated based on the command text template corresponding to the to-do type and the target text data.

As shown in FIG. 3, the extraction command text for the target text data is generated based on the to-do type of the target text data output by the classification model.

Taking the above-mentioned command text template and the target text data as an example, the command text template is spliced with the target text data to obtain the command for processing the target text data. The generated command for processing the target text data is as follows.

The following is a text fragment, please summarize a content that needs to see and summarize a to-do item in combination with the content. Requirements: 1. A specific to-do item needs to be output. 2. The output format must be “to-do item: xx”, and the length of the to-do item is not greater than 40 words.

The text fragment is as follows.

Speaker 1: I want to see the analysis result of the experimental data.

Speaker 2: OK, I will send it to you after collation.

The extraction command text for the target text data is input to the natural language processing tool to obtain the to-do data output by the natural language processing tool.

As shown in FIG. 3, the extraction command text for the target text data is input to the natural language processing tool to obtain the to-do data.

Taking the above example as an example, the to-do data output by the natural language processing tool is “to-do item: collate the analysis result of the experimental data and send it to Speaker 1”.

The target text data is processed using the natural language processing tool such that the generated to-do data is more fluent and convenient for the user to view.

Based on the method for extracting a to-do item provided by the above method embodiments, the embodiments of the present application further provide an apparatus for extracting a to-do item. The apparatus for extracting a to-do item will be described below with reference to the accompanying drawings.

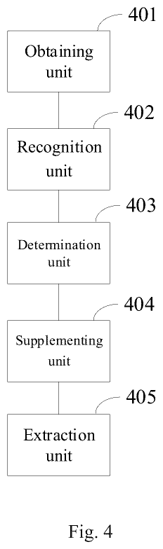

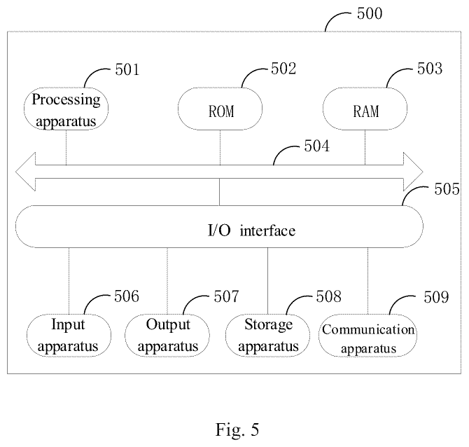

With reference to FIG. 4, which shows a structural schematic diagram of an apparatus for extracting a to-do item provided by the embodiments of the present disclosure. As shown in FIG. 4, the apparatus for extracting a to-do item includes:
an obtaining unit 401, configured to obtain text data to be processed;
a recognition unit 402, configured to identify one or more pieces of original text data from the text data to be processed, in which the original text data is related to a to-do item;
a determination unit 403, configured to, for one piece of original text data of the one or more pieces of original text data, determine an information quantity of the piece of original text data;
a supplementing unit 404, configured to, in response to the information quantity of the piece of original text data not satisfying a preset condition, supplement the piece of original text data with the text data to be processed; and
an extraction unit 405, configured to extract to-do data from the piece of original text data.

In a possible implementation, the recognition unit 402 is specifically configured to obtain, by using a sentence recognition model, the one or more pieces of original text data based on the text data to be processed.

In a possible implementation, the apparatus further includes:
a sentence dividing unit, configured to divide the text data to be processed into sentences to obtain text data of a plurality of sentences to be processed.

The recognition unit 402 is specifically configured to identify, by using the sentence recognition model, the one or more pieces of original text data from the text data of the plurality of sentences to be processed.

In a possible implementation, the sentence recognition model is trained by:
obtaining first training data, in which the first training data includes a positive sample and a negative sample; the positive sample is text data including information of a to-do item, and the negative sample is text data not including information of a to-do item; and
training the sentence recognition model with the first training data until a first condition is satisfied, to obtain the trained sentence recognition model.

In a possible implementation, the determination unit 403 is configured to determine an information quantity of the piece of original text data.

Specifically, the determination unit 403 is configured to obtain, by using an information quantity recognition model, the information quantity of the piece of original text data based on the piece of original text data.

In a possible implementation, the information quantity recognition model is trained by:
obtaining second training data, in which the second training data includes training text data and a label corresponding to the training text data, and the label is used to represent an information quantity of the training text data; and
training the information quantity recognition model with the second training data until a second condition is satisfied, to obtain the trained information quantity recognition model.

In a possible implementation, the supplementing unit 404 is configured to supplement the piece of original text data with the text data to be processed.

The supplementing unit 404 is specifically configured to supplement the piece of original text data with first text data adjacent to the piece of original text data in the text data to be processed.

In a possible implementation, the supplementing unit 404 is further configured to, in response to the piece of original text data after supplementing meets a supplementing condition, supplement the piece of original text data with second text data adjacent to the piece of original text data in the text data to be processed.

In a possible implementation, the supplementing condition is that a word count of the piece of original text data is less than a word count threshold, or the supplementing condition is that a sentence structure of the piece of original text data is insufficient.

In a possible implementation, the extraction unit 405 is specifically configured to extract the piece of original text data using a natural language processing tool to obtain the to-do data.

In a possible implementation, the extraction unit 405 is specifically configured to extract the piece of original text data using the natural language processing tool to obtain the to-do data, which includes the following steps.

The extraction unit 405 is specifically configured to: determine a to-do type of the piece of original text data; generate an extraction command text for the piece of original text data based on a command text template corresponding to the to-do type and the piece of original text data; and input the extraction command text to the natural language processing tool to obtain the to-do data output by the natural language processing tool.

In a possible implementation, the apparatus further includes:
a creation unit, configured to create a to-do task based on the to-do data.

In a possible implementation, the apparatus further includes:
a push unit, configured to push information of the to-do task to a user associated with the to-do task.

Based on the method for extracting a to-do item provided by the above method embodiments, the present disclosure further provides an electronic device, which includes: one or more processors; and a storage apparatus storing one or more programs, the one or more programs, when executed by the one or more processors, cause the one or more processors to implement the method for extracting a to-do item as described in any of the above embodiments.

Referring to FIG. 5, FIG. 5 illustrates a schematic structural diagram of an electronic device 500 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The electronic device provided by the embodiments of the present disclosure and the method for extracting a to-do item provided by the above embodiments belong to the same inventive concept. Technical details not fully described in this embodiment can be found in the above embodiments, and this embodiment has the same beneficial effect as the above embodiments.

Based on the method for extracting a to-do item provided by the above method embodiments, the embodiments of the present disclosure further provides a computer-readable medium, which stores a computer program thereon, the computer program, when executed by a processor, implements the method for extracting a to-do item provided by any of the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the above method for extracting a to-do item.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the speech data collection module can also be described as a “data collection module”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that each embodiment in the present disclosure is described in a progressive manner, and each embodiment focuses on the differences from other embodiments. The same and similar parts between each embodiment can be referred to each other. For the system or device disclosed in the embodiments, the description is relatively simple as it corresponds to the methods disclosed in the embodiments. Please refer to the method section for relevant information.

It should be understood that, in the present disclosure, “at least one (item)” refers to one or more, and “a plurality” refers to two or more. “And/or” is used to describe the association relationship of associated objects, indicating that there can be three types of relationships. For example, “A and/or B” can represent three situations: only A exists, only B exists, and A and B exist simultaneously, in which A, B can be singular or plural. The character “/” generally indicates that the associated object is an “or” relationship. “At least one of the following items” or its similar expression refers to any combination of these items, including any combination of single or complex items. For example, at least one term of a, b and c can represent: a, b, c, “a and b”, “a and c”, “b and c”, or “a and b and c”, in which a, b, c can be single or plural.

It should also be noted that, in the present disclosure, relational terms such as first and second are only used to distinguish one entity or operation from another entity or operation, and do not necessarily require or imply any actual relationship or order between these entities or operations. Moreover, the terms “including”, “comprising”, or any other variation thereof are intended to encompass non-exclusive inclusion, such that a process, method, item, or device that includes a series of elements not only includes those elements, but also includes other elements that are not explicitly listed, or also includes elements inherent to such process, method, item, or device. Without further limitations, the element limited by the statement “including a . . . ” do not exclude the existence of other elements in the process, method, item, or device that includes the said element.

The above illustration of the embodiments of the present disclosure enables professionals in the art to implement or use this disclosure. The various modifications to these embodiments will be apparent to professionals in the art, and the general principles defined in the present disclosure can be implemented in other embodiments without departing from the spirit or scope of the present disclosure. Therefore, the present disclosure will not be limited to the embodiments illustrated herein.

1. A method for extracting a to-do item, comprising:
obtaining text data to be processed;
identifying one or more pieces of original text data from the text data to be processed, wherein the original text data is related to a to-do item;
for one piece of original text data of the one or more pieces of original text data, determining an information quantity of the piece of original text data;
in response to the information quantity of the piece of original text data not satisfying a preset condition, supplementing the piece of original text data with the text data to be processed; and
extracting to-do data from the piece of original text data.

2. The method according to claim 1, wherein the identifying one or more pieces of original text data from the text data to be processed comprises:
obtaining, by using a sentence recognition model, the one or more pieces of original text data based on the text data to be processed.

3. The method according to claim 2, before obtaining, by using a sentence recognition model, the one or more pieces of original text data based on the text data to be processed, further comprising:
dividing the text data to be processed into sentences to obtain text data of a plurality of sentences to be processed;
wherein the obtaining, by using a sentence recognition model, the one or more pieces of original text data based on the text data to be processed comprises:
identifying, by using the sentence recognition model, the one or more pieces of original text data from the text data of the plurality of sentences to be processed.

4. The method according to claim 2, wherein the sentence recognition model is trained by:
obtaining first training data, wherein the first training data comprises a positive sample and a negative sample; the positive sample is text data comprising information of a to-do item, and the negative sample is text data not comprising information of a to-do item; and
training the sentence recognition model with the first training data until a first condition is satisfied, to obtain a trained sentence recognition model.

5. The method according to claim 1, wherein the determining an information quantity of the piece of original text data comprises:
obtaining, by using an information quantity recognition model, the information quantity of the piece of original text data based on the piece of original text data.

6. The method according to claim 5, wherein the information quantity recognition model is trained by:
obtaining second training data, wherein the second training data comprises training text data and a label corresponding to the training text data, and the label is used to represent an information quantity of the training text data; and
training the information quantity recognition model with the second training data until a second condition is satisfied, to obtain a trained information quantity recognition model.

7. The method according to claim 1, wherein the supplementing the piece of original text data with the text data to be processed comprises:
supplementing the piece of original text data with first text data adjacent to the piece of original text data in the text data to be processed.

8. The method according to claim 7, further comprising:
in response to the piece of original text data after supplementing satisfying a supplementing condition, supplementing the piece of original text data with second text data adjacent to the piece of original text data in the text data to be processed.

9. The method according to claim 8, wherein the supplementing condition is that a word count of the piece of original text data is less than a word count threshold, or the supplementing condition is that a sentence structure of the piece of original text data is insufficient.

10. The method according to claim 1, wherein the extracting to-do data from the piece of original text data comprises:
processing the piece of original text data using a natural language processing tool to obtain the to-do data.

11. The method according to claim 10, wherein the processing the piece of original text data using a natural language processing tool to obtain the to-do data comprises:
determining a to-do type of the piece of original text data;
generating an extraction command text for the piece of original text data based on a command text template corresponding to the to-do type and the piece of original text data; and
inputting the extraction command text to the natural language processing tool to obtain the to-do data output by the natural language processing tool.

12. The method according to claim 1, further comprising:
creating a to-do task based on the to-do data.

13. The method according to claim 12, further comprising:
pushing information of the to-do task to a user associated with the to-do task.

14. An electronic device, comprising:
one or more processors; and
a storage apparatus, storing one or more programs,
wherein the one or more programs, when executed by the one or more processors, cause the one or more processors to implement a method for extracting a to-do item, the method comprises:
obtaining text data to be processed;
identifying one or more pieces of original text data from the text data to be processed, wherein the original text data is related to a to-do item;
for one piece of original text data of the one or more pieces of original text data, determining an information quantity of the piece of original text data;
in response to the information quantity of the piece of original text data not satisfying a preset condition, supplementing the piece of original text data with the text data to be processed; and
extracting to-do data from the piece of original text data.

15. The electronic device according to claim 14, wherein the identifying one or more pieces of original text data from the text data to be processed comprises:
obtaining, by using a sentence recognition model, the one or more pieces of original text data based on the text data to be processed.

16. The electronic device according to claim 15, wherein, before obtaining, by using a sentence recognition model, the one or more pieces of original text data based on the text data to be processed, the method further comprises:
dividing the text data to be processed into sentences to obtain text data of a plurality of sentences to be processed;
wherein the obtaining, by using a sentence recognition model, the one or more pieces of original text data based on the text data to be processed comprises:
identifying, by using the sentence recognition model, the one or more pieces of original text data from the text data of the plurality of sentences to be processed.

17. The electronic device according to claim 15, wherein the sentence recognition model is trained by:
obtaining first training data, wherein the first training data comprises a positive sample and a negative sample; the positive sample is text data comprising information of a to-do item, and the negative sample is text data not comprising information of a to-do item; and
is satisfied, to obtain a trained sentence recognition model.

18. The electronic device according to claim 14, wherein the determining an information quantity of the piece of original text data comprises:
obtaining, by using an information quantity recognition model, the information quantity of the piece of original text data based on the piece of original text data.

19. The electronic device according to claim 14, wherein the supplementing the piece of original text data with the text data to be processed comprises:
supplementing the piece of original text data with first text data adjacent to the piece of original text data in the text data to be processed.

20. A non-transitory computer-readable medium, storing a computer program thereon, wherein the computer program, when executed by a processor, implements a method for extracting a to-do item, the method comprises:
obtaining text data to be processed;
identifying one or more pieces of original text data from the text data to be processed, wherein the original text data is related to a to-do item;
for one piece of original text data of the one or more pieces of original text data, determining an information quantity of the piece of original text data;
in response to the information quantity of the piece of original text data not satisfying a preset condition, supplementing the piece of original text data with the text data to be processed; and
extracting to-do data from the piece of original text data.
